(19) United States
(12) Patent Application Publication
(10) Pub. No.: US 2010/0078598 A1
(43) Pub. Date: Apr. 1, 2010

(54) CONDUCTIVE POLYMER COMPOSITION FOR RADIOGRAPHIC IMAGING

(75) Inventors: Suck Hyun Lee, Gyeonggi-do (KR); Dong Jin Woo, Gyeonggi-do (KR); Jin Young Choi, Gyeonggi-do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignees: ELPANI CO., LTD., Gyeonggi-do (KR); AJOU UNIVERSITY INDUSTRY-ACADEMIC COOPERATION FOUNDATION, GYEONGGI-DO (KR)

(21) Appl. No.: 12/524,400

(22) PCT Filed: Jan. 25, 2008
(86) PCT No.: PCT/KR08/00481

§ 371 Date: Jul. 24, 2009

(30) Foreign Application Priority Data
Jan. 25, 2007 (KR) 10-2007-0007773
Jan. 17, 2008 (KR) 10-2008-0005198

(51) Int. Cl. H01B 1/12

(52) U.S. Cl. 252/501.1

(57) ABSTRACT

The present invention provides a conductive polymer composition for radiographic imaging prepared by mixing a photosensitive compound, such as a carbon nanotube, a photodegradable dopant, a photocuririg agent, an organic electron acceptor including a halogen atom, a Lewis basic dopant, and a pseudodopant, with a conductive polymer, the conductive polymer composition for radiographic imaging showing an electrical resistance variation amplified by radiation. When a photosensitive compound is mixed with a conductive polymer in accordance with the present invention, it is possible to effectively amplify the electrical resistance variation of the thus obtained composition by radiation, and thus it is possible to effectively detect and record radiation of low dose. That is, when the amplified electrical resistance variation is processed into an electrical signal, it is possible to facilitate the detection and recording of radiation, i.e., high-energy light, such as X-rays, gamma-rays, electron beams, and neutron beams.

### TECHNICAL FIELD

The present invention relates to a conductive polymer composition for radiographic imaging and, more particularly, to a conductive polymer composition for radiographic imaging prepared by mixing a photosensitive compound, such as a carbon nanotube, a photodegradable dopant, a photocuring agent, an organic electron acceptor including a halogen atom, a Lewis basic dopant, and a pseudodopant, with a conductive polymer, the conductive polymer composition for radiographic imaging showing an electrical resistance variation amplified by radiation.

### BACKGROUND ART

Conventionally used halogen-silver films for X-ray diagnosis have a low sensitivity to X-rays; however, when a fluorescent screen is used together, there are advantages in that spatial resolution is increased and image distribution can be obtained by a one time photographing operation. However, the halogen-silver films for X-ray diagnosis have also drawbacks in that light should be blocked until developed, a wet process is required, handling is difficult, and environmental contamination is caused. Recently, a material that can be utilized to low-dose high-quality digital imaging has been required.

In recent years, conductive polymers are utilized for the purposes of detection and recording of high-energy light (hereinafter referred to as radiation) such as X-rays, gamma-rays, electron beams, and neutron beams. The conductive polymers are polymers which have been known to the general public since Alan J. Heeger, Alan G. MacDiarmid and Hideki Shirakawa were awarded the Noble Prize for Chemistry in 2000, and are often called a fourth generation plastic. The conductive polymers have characteristics that they do not merely play a passive role such as an insulator but they are intrinsically conductive polymers showing an electrical conductivity of several thousand siemens/cm when doped. Moreover, the conductive polymers have semiconductor characteristics like inorganic semiconductors, and thus can be used in various applications such as solar cells. The important conductive polymers well known in the art include polyacetylene, polyaniline, polypyrrole, polythiophene, polyphenylenevinylene, polyphenylene sulfide, polyisothianaphthene, polyperinaphthalene, polyparaphenylene, etc. Among them, the polyaniline has attracted much attention, since it is very stable in the air and capable of being easily synthesized. The polyaniline can be classified into leucoemeraldine that is a completely reduced form, emeraldine that is a partially oxidized form, and pernigraniline that is a fully oxidized form according to its oxidation state.

It has been reported that, when the intrinsically conductive polymer is doped by a redox reaction or an acid-base reaction, polarons are formed to move electrons, and thus conductive polymer is electrified. Moreover, it has been reported that when it is exposed to high-energy light, the electrons generated by the light have an effect on the doping state, and thus the electrical conductivity is increased or reduced.

In an early stage, Arca et al. reported that, when polypyrrole film is exposed to gamma-ray irradiation, the electrical conductivity is substantially increased (Radiation Physics and Chemistry, 31, 647, 1988). Wolszczak et al. reported that polyaniline has characteristics that a sample in the form of emeraldine base before doping has an electrical conductivity increased by an effect of gamma-rays or electron beams, and a sample in the form of emeraldine salt is opposite to that (Radiation Physics and Chemistry, 45, 71, 1995). Azevedo et al. reported that the electrical conductivity is increased or reduced according to the doses of gamma-rays (Radiation Protection Dosimetry, 84, 77, 1999). Pashchuk et al. reported that, when polyaniline is exposed to an X-ray dose in the range of 50 to 100 KeV, the resistance is increased according to the dose (Brazilian Journal of Physics, 35, No. 3B, 847, 2005). Sevil et al. reported that, when a composite of polyaniline with polyvinyl chloride or chlorinated polypropylene is exposed to gamma-ray and electron beam irradiation, an increase in resistance is observed (Radiation Physics and Chemistry, 65, 575, 2003). According to the above-described research results, the sensitivity is too low to be put to practical use, and the characteristics of conductive polymers are deteriorated.

Besides, Allport et al. discloses an X-ray detector using polyalkylthiophene as a semiconductor material in PCT Publication No. WO/2001/094980. Patel et al. (U.S. Pat. No. 5,420,000, Bloom et al. (U.S. Pat. No. 4,066,676), and Adelman et al. (U.S. Pat. No. 3,501,308) disclose a polydiacetylene-based photochromic material. Furthermore, Robillard discloses a photocurable polymer as an X-ray recording material in U.S. Pat. No. 5,364,739. However, there are limitations on their preparation methods and composite compositions to use these photoconversion materials for detecting or recording high-energy light such as X-rays.

Meanwhile, the inventors of the present invention has prepared and discloses a conductive polymer having an electrical conductivity three to five times higher than the conventional conductive polymers and a high purity as a conductive polymer exhibiting a pure metallicity (Nature 441, 65, 2006).

### DISCLOSURE

### Technical Problem

The inventors have conducted extensive research to solve the problems of the conventional conductive polymers for radiographic imaging, in that the sensitivity is too low to be put to practical use. As a result, the inventors have found that the electrical resistance variation (i.e., sensitivity) of a composition prepared by mixing a photosensitive compound with a conductive polymer can be effectively amplified by radiation, and thus it is possible to effectively detect and record radiation of low dose.

Accordingly, the present provides a conductive polymer composition for radiographic imaging showing an electrical resistance variation amplified by radiation.

### Technical Solution

In one aspect, the present invention provides a conductive polymer composition for radiographic imaging prepared by mixing 0.1 to 2 equivalent of at least one photosensitive compound selected from the group consisting of a carbon nanotube, a photodegradable dopant, a photocuring agent, an organic electron acceptor including a halogen atom, a Lewis basic dopant, and a pseudodopant, with one equivalent of a conductive polymer, the conductive polymer composition for radiographic imaging showing an electrical resistance variation amplified by radiation.

In the conductive polymer composition for radiographic imaging showing an electrical resistance variation amplified by radiation in accordance with the present invention, the photosensitive compound is at least one selected from the group consisting of fullerene, fullerene having a sulfonyl group, triphenylsulfonium triflate, trimethylbenzhydrylammonium iodide, carbon nanotube, EuCl₃, diphenyliodonium hexafluorophosphate, 1-hydroxycyclohexylphenylketone, SAL 605, o-chloranil, gadolinium chloride (GdCl₃), N-methylnifedipine, AgNO₃, NdCl₃, triphenylsulfonium hexafluoroantimonate, and terephthalic acid having two diacetylene derivatives [—O—(CH₂)₄—C≡C—C≡C—(CH)₉—CH₃] substituted on an aromatic ring.

### ADVANTAGEOUS EFFECTS

When a photosensitive compound is mixed with a conductive polymer in accordance with the present invention, it is possible to effectively amplify the electrical resistance variation of the thus obtained composition by radiation, and thus it is possible to effectively detect and record radiation of low dose. That is, when the amplified electrical resistance variation is processed into an electrical signal, it is possible to facilitate the detection and recording of radiation, i.e., high-energy light, such as X-rays, gamma-rays, electron beams, and neutron beams. Moreover, the composition for radiographic imaging having the amplified electrical resistance variation can provide an image at a molecular level and, since the thus obtained image can be easily converted into digital information, it can be utilized as an imaging material for next generation radiographic diagnosis and treatment, which can substitute for the conventional organic semiconductors, such as amorphous silicon or selenium, and halogen-silver films. Furthermore, since there is no limitation such as a band gap, the available energy range of light is wide, and thus it can be used in various applications such as curing of polymer coatings, high quality recording of image and information, nondestructive testing, food sterilization testing, security test, and the like.

### DESCRIPTION OF DRAWINGS

FIG. 1 is a current-voltage curve of a composition in accordance with Example 5 of the present invention;

FIG. 2 is a current-voltage curve of a composition in accordance with Example 14 of the present invention before and after X-ray irradiation; and

FIG. 3 is a current-voltage curve of a composition in accordance with Example 7 of the present invention before and after X-ray irradiation.

### MODE FOR INVENTION

In the present specification, a “radiation” is referred to as high-energy light, such as X-rays, gamma-rays, electron beams, and neutron beams, and the high-energy light is generally in the range of 4 eV to 20 MeV.

Moreover, a “radiographic imaging” is directed to a technique that visually images a subject by detecting and/or recoding the radiation, and a “composition for radiographic imaging” is directed to a composition that can be used in the radiographic imaging. For example, a conductive polymer composition for radiographic imaging is a composition containing a conductive polymer and is designated as a composition used in the radiographic imaging.

In accordance with one embodiment of the present invention, there is provided a conductive polymer composition for radiographic imaging prepared by mixing 0.1 to 2 equivalent of at least one photosensitive compound selected from the group consisting of a carbon nanotube, a photodegradable dopant, a photocuring agent, an organic electron acceptor including a halogen atom, a Lewis basic dopant, and a pseudodopant, with one equivalent of a conductive polymer, the conductive polymer composition for radiographic imaging showing an electrical resistance variation amplified by radiation.

In accordance with another embodiment of the present invention, there is provided a method of amplifying an electrical resistance variation of a conductive polymer composition for radiographic imaging by radiation, the method comprising the step of preparing a composition for photographic imaging by mixing 0.1 to 2 equivalent of at least one photosensitive compound selected from the group consisting of a carbon nanotube, a photodegradable dopant, a photocuring agent, an organic electron acceptor including a halogen atom, a Lewis basic dopant, and a pseudodopant, with one equivalent of a conductive polymer.

The conductive polymer used in the conductive polymer composition for radiographic imaging showing an electrical resistance variation amplified by radiation may include polyacetylene having or not having an alkyl or alkoxy substituent as a substituent, and a conductive polymer having a hetero atom such as polyaniline (PANT) having or not having a substituent on an aromatic ring, polypyrrole (PPy) having or not having a substituent on an aromatic ring, and polythiophene (PT) having or not having a substituent on an aromatic ring.

The hetero atom of the conductive polymer may have a substituent of di-tert-butyl-dicarbonate, and/or 3,4-dihydro-2H-pyran-tert-butyl-dicarbonate. Moreover, the aromatic ring of the conductive polymer having a hetero atom may have at least one substituent selected from the group consisting of I, Cl, Br, and (—OCH₂CH₂)ₙ—OCH₂CH₃ wherein n is an integer from 1 to 12.

The conductive polymer having a hetero atom may be synthesized from an aniline monomer represented by the following formula 1, a pyrrole monomer represented by the following formula 2, and a thiophene monomer represented by the following formula 3 by self-stabilized dispersion polymerization published in Advanced Functional materials (15, 1495, 2005). The polymer material synthesized by the above polymerization method has a lower molecular weight and a higher conductivity than those of polymer materials synthesized by the conventional methods. The molecular weight of the polymer material synthesized by the above polymerization method may be more than 5,000 and, preferably, in the range of 12,000 to 180,000.

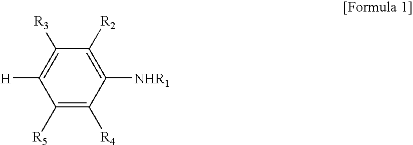

In formula 1, R₁ represents hydrogen, alkyl, alkoxy, tert-butoxycarbonyl, or tetrahydropyran, and R₂, R₃, R₄, and R₅ independently represents hydrogen, alkyl, alkenyl, alkoxy, oligo(ethylene oxide), alkylhioalkyl, alkanoyl, alkylthio, arylalkyl, alkylamino, amino, alkoxycarbonyl, alkylsulfonyl, alkylsulfinyl, arylthio, sulfonyl, carboxyl, hydroxyl, halogen, nitro, or alkaryl. Preferably, R₂, R₃, R₄, and R₅ represent hydrogen, respectively.

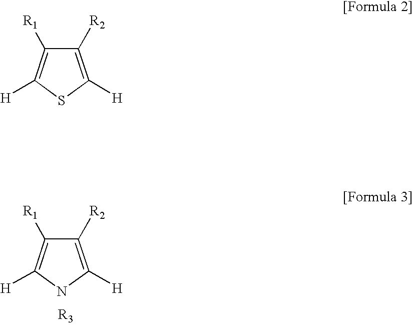

In formulas 2 and 3, R₁ and R₂ independently represent hydrogen, alkyl, alkoxy, oligo(ethylene oxide), alkylhioalkyl, alkanoyl, alkylthio, arylalkyl, alkylamino, amino, alkoxycarbonyl, alkylsulfonyl, alkylsulfinyl, arylthio, sulfonyl, carboxyl, hydroxyl, halogen, nitro, or alkaryl, and R₃ represents hydrogen, tert-butoxycarbonyl, or tetrahydropyran. Preferably, R₁ and R₂ represent hydrogen, respectively.

In the present specification including the definition of the substituents of the above formulas 1 to 3, alkyl, alkoxy, and alkanoyl represent C₁-C₂₄ alkyl, C₁-C₂₄ alkyl, and C₁-C₂₄ alkanoyl, and alkenyl represents C₂-C₂₄ alkenyl.

The conductive polymer may be used in the form of a base without any doping process or in the form of a conductive polymer salt after a doping process for controlling the conductivity. A dopant used in the doping process for controlling the conductivity may be an organic acid or inorganic acid that donates a proton (H⁺) having a pKa of less than 5. The organic acid or inorganic acid is represented by the generic formula HA wherein H represents H⁺, and A represents an anion such as Cl⁻, Br⁻, I⁻, PO₃⁻, SO₄⁻, PO₄⁻, ClO₄⁻, CH₃SO₃⁻, or a polymer anion. The organic acid or inorganic acid may include hydrochloric acid, bromic acid, sulfuric acid, pyruvic acid, phosphoric acid, dichloroacetic acid, acrylic acid, citric acid, formic acid, methanesulfonic acid, benzenesulfonic acid, p-toluenesulfonic acid, camphorsulfonic acid, dodecylbenzenesulfonic acid, dinonylnaphthalenesulfonic acid, poly(styrenesulfonic acid), polyacrylic acid, heteropolyanion, C₁-C₂₄ alkyl, oxidized C₁-C₂₄ alkyl 4-sulfophthalic acid diester, 4-sulfo-1,2-benzenecarboxylic acid C₁-C₂₄ alkyl ester, bis(2-ethylhexyl)hydrogen phosphate, and 2-acrylamido-2-methyl-1-propanesulfonic acid.

The photosensitive compound mixed to amplify the electrical resistance variation of the conductive polymer by radiation may have a molecular weight of less than 2,000, and the photosensitive compound may include at least one selected from the group consisting of a carbon nanotube; four types of dopants such as a photodegradable dopant, a photocuring agent, an organic electron acceptor including a halogen atom, and a Lewis basic dopant; and a pseudodopant. The equivalent ratio of the conductive polymer to the photosensitive compound may be in the range of 1:0.1 to 1:2.

The first photodegradable dopant among the four types of dopants is a material that generates either an acid or a base by light irradiation, in which the former is called a photoacid generator and the latter is called a photobase generator. Any compound that can generate either an acid or a base by light irradiation can be used in the present invention.

Preferably, the photoacid generator may include 4,4′-isopropylidene-bis-(2,6-dibromophenol), triphenylsulfonium hexafluorophosphate, triphenylsulfonium hexafluoroantimonate, triphenylsulfonium hexafluoroarsenate, triphenylsulfonium triflate, diphenyl (4-methoxyphenyl)sulfonium triflate, diphenyliodonium hexafluorophosphate, diphenyliodonium hexafluoroantimonate, 4-methoxydiphenyliodonium triflate, (4-hydroxycyclohexyl)cyclohexyl-4-vinylbenzenesulfonate, (4-hydroxycyclohexyl)cyclohexyl-4-methylbenzenesulfonate, 4-hydroxycyclohexyl-4-vinylbenzenesulfonate, 4-hydroxycyclohexyl-4-methylbenzenesulfonate, and SAL 605 (a composite containing a novolak resin, hexamethoxymethylmelamine that is a photocuring agent, and a photoacid generator).

The photobase generator is a material that forms an amine or ammonium compound by irradiation of ultraviolet rays, and may include [(2,6-dinitrobenzyl)oxycarbonyl]diphenylamine, [(2,6-dinitrobenzyl)oxycarbonyl]cyclohexylamine), [(2,6-dinitrobenzyl)oxycarbonyl]hexane-1,6-diamine, N-methylnifedipine, quaternary ammonium dithiocarbamate, trimethylbenzhydrylammonium triflate, trimethylbenzhydrylammonium iodide, trimethylflorenylammonium iodide, o-nitrobenzyl carbamate, trimethylbenzhydrylammonium iodide), and O-acryloyl acetophenone oxime.

The photocuring agent of the second type is a compound that can induce curing of the polymer by light irradiation and be effectively used by varying the solubility as well as the conductivity. Preferably, the photocuring agent may include 1-hydroxycyclohexylphenylketone and diacetylene derivative. As the diacetylene derivative, any form of photochromic materials, in which a monomer crystal or an oriented material can be polymerized into polydiacetylene by light irradiation through topochemical polymerization, can be used. However, it is preferable to use the diacetylene derivative that is self-oriented by a simple process. For example, the diacetylene derivative may be aromatic 1,4-dicarboxylic acid having a carboxyl group attached to the para position, the aromatic dicarboxylic acid having at least one —O—(CH₂)ₚ—C≡C—C≡C—(CH₂)_{q}—CH₃, or —O—(CH₂)ₚ—C≡C—C≡C—(CH₂)_{q}—CH₃ and —O—(CH₂)ᵣ—CH₃ wherein p, q and r are independently integers from 1 to 12, attached to an aromatic ring. The preparation method of the diacetylene derivative is disclosed in a paper (Angew. Chem. Int. Ed., 43, 4197, 2004) by the inventors.

The organic electron acceptor including a halogen atom of the third type may include I₂, Br₂, tetracyanoethylene (TCNE), 2,3-dichloro-5,6-dicyano-p-benzoquinone, o-chloranil, and o-bromanil.

The Lewis basic dopant of the fourth type may be a chloride, a nitrogen oxide or a phosphorus oxide of rare earth elements and transition metal elements such as Gd³⁺, Eu³⁺, La³⁺, Y³⁺, Lu³⁺, Ce³⁺, Nd³⁺, Tb³⁺Zn²⁺, Mn²⁺, Ni²⁺Cu²⁺, Pb²⁺, Pd²⁺, Ca²⁺, Fe³⁺, Au³⁺, Ti⁴⁺, Sn⁴⁺, Zr⁴⁺, Mo⁵⁺, Ag¹⁺, or W⁶⁺.

The pseudodopant may include LiPF₆ LiAsF₆, LiClO₄, LiBF₄, and NaBF₄.

The conductive polymer composition for radiographic imaging showing an electrical resistance variation amplified by radiation may further include a binder resin and a plasticizer other than the conductive polymer and at least one photosensitive compound in order to improve tackiness and impact resistance and prevent toxicity induced by elution of a component of the composition.

Moreover, the conductive polymer composition for radiographic imaging in accordance with the present invention may be applied to various plastic films having a thickness of 10 to 300 microns, paper, and metal foils such as aluminum as a matrix material. The matrix material may be subjected to a plasma process to improve the tackiness. Moreover, it is necessary to select binder resins having various polarities according to the properties of the matrix material. Although it is not necessary that these binder resins should form composites with special dopants, it is possible to form a composite with a metal salt to increase the radiation sensitivity. Moreover, when the composition for radiographic imaging is coated, it may be affected by moisture in the air. Accordingly, the tackiness of the binder resin that is sensitive to moisture may be varied according to the climate, and thus it is preferable to appropriately select the binder resin on occasion demands.

The binder resin available regardless of the kind of the matrix materials may include polyvinyl acetate, polyacrylic acid, polyol, acrylate-styrene copolymer, polyethylene glycol, polyvinyl alcohol, polyvinylpyrrolidone, polyvinyl chloride (PVC), polyacrylate, nitrocellulose, poly[(2-hydroxyethyl methacrylate)-co-(allyl methacrylate)], poly(butene-1-sulfone), poly(2,3-dichloro-1-propylacrylate), poly(2-fluoroethyl methacrlyate), ethylvinylacetate copolymer, cellulose triacetate, hydroxyethylcellulose, poly(hexafluorobutyl methacrylate), polymethacrylonitrile, gelatin, polyisobutyl methacrylate, polyvinyl-2-furylacrylate), poly(vinylcinnamilidene acetate), chlorinated polypropylene, polyvinylphenol, halogen-substituted polyvinylphenol, polyethyleneimine, nitrocellulose, celluloseacetatebutylate, and cellulose propionate. It is preferable that the binder resin has a molecular weight in the range of 10,000 to 3,000,000 in consideration of the effect on viscosity.

Moreover, the available plasticizer may include propionic acid, heptanoic acid, boric acid, 4-sulfophthalic acid diester, and 4-sulfo-1,2-benzenedicarboxylic acid. Furthermore, as the plasticizer, a dopant-plasticizer that serves as a dopant and provides a plasticity may be preferably used to increase the durability. The dopant-plasticizer may include di-2-ethylhexylsulfosuccinic acid, 1,2-benzenedicarboxylic acid, 4-sulfo-1,2-di(2-alkyl)ester, 1,2-benzenedicarboxylic acid, 4-sulfo-1,2-di(2-alkoxy)ester, diisooctyl phosphate, di(m-tolyl)phosphate, and diphenyl phosphate.

In the case where the binder resin and the plasticizer are used, a converter material that converts high energy light into low energy light (more than 4 eV) may further included. Especially, when the subject contrast is a more important factor than the image sharpness, it is necessary to amplify the image with the use of the converter material. When a small quantity of an inorganic oxide particle such as barium iodide (BaI₂) is added, it is more sensitive to X-rays of 60 KeV than X-rays for diagnosis of 100 MeV. Especially, it has been found that, since most of the photosensitive compounds used in the present invention are sensitive to ultraviolet rays, when light having an energy such as ultraviolet rays is exposed to high energy light irradiation, the effect is increased. When X-rays of less than 1 MeV are irradiated to a material, some of materials may present light. For example, a typical material that presents white light by irradiation of X-rays for diagnosis is an intensifying screen or a phosphor screen. The converter proposed by the present invention may be formed into a separate converter layer with the binder resin and used in combination with a conductive layer in order to increase the sensitivity, not affecting the electrical conductivity. The available converter material used with the composition of the present invention may include barium titanate, MgO, barium silicate, BaI₂, BaSO₄, BaBr₂, SnI₄, H₂WO₄, ZnO, CsBr, CsI, ZnS, Gd₂O₂S, Y₂O₂S, CaWO₃, H₃BO₃, ZnSiO₄, ZnBr₂, ZnSO₄, PbI₂, and Na⁺-montmorillonite.

Next, the present invention will be described in more detail with reference to Preparation Examples and Examples. However, the following Preparation Examples and Examples are provided only for illustrations and thus the present invention is not limited to or by them.

### Preparation Example 1

### Synthesis of Conductive Polymer Polyaniline

100 mL of distilled and purified aniline was slowly added dropwise to 3 L of 1 M HCL solution and then 8 L of chloroform was mixed with the resulting solution. While lowering the temperature of the mixed solution from −15° C. at a rate of 0.1° C./min, a solution in which 56 g of ammonium persulfate [(NH₄)₂S₂O₈] as an initiator was dissolved in 1 L of 1 M HCL solution was added dropwise to the mixed solution for 20 minutes while stirring. After the completion of the addition of the initiator, the temperature was maintained constant for 5 hours and then the temperature was increased at a rate of 1° C./min. Here, the stirring rate was maintained 100 rpm/min. The precipitate obtained after the reaction was filtered with a filter paper to collect polyaniline in the form of a base. A portion of the collected polyaniline was washed with 1 L of 1 M ammonium hydroxide (NH₄OH) solution. The precipitate was transferred into 5 L aqueous solution of 0.1 M ammonium hydroxide, stirred for 20 hours, filtered, and then dried by a vacuum pump for 48 hours to yield 1.9 g of polyaniline in the form of emeraldine base.

The synthesized polymer was analyzed with an infrared spectrometer. As a result, the vibration absorption bands were shown at a peak of about 1590 cm⁻¹ attributable to a typical quinoid structure, at a peak of about 1495 cm⁻¹ attributable to a benzenoid structure, and at a peak of about 3010 cm⁻¹, resulted from the stretching vibration of C—H of aromatic ring. Moreover, as the results of solution state ¹³C NMR spectrum analysis, the chemical shifts of the aromatic carbons had characteristic peaks at 118 ppm, 137 ppm and 141 ppm, respectively, and thus the synthesis of the polyaniline was confirmed.

### Preparation Example 2

### Synthesis of Conductive Polymer Polypyrrole

500 mL of chloroform was slowly added to 2.0 L of 1 M HCL solution, in which 68 g (1 mol) of distilled and purified pyrrole was dissolved, at a temperature of −5° C. 200 mL of solution, in which 0.2 mol of ammonium persulfate [(NH₄)₂S₂O₈] as an initiator was dissolved, was added dropwise in the mixed solution while stirring for 20 minutes. After the reaction for 40 hours, methanol precipitation and precipitate were washed with distilled water, filtered, and then dried. The precipitate was immersed in 1 L solution of 1 M ammonium hydroxide and, after 20 hours, filtered and dried to yield 20 g of undoped polypyrrole. The intrinsic viscosity of the solution dissolved in N-methylpyrrolidone (NMP) solvent was 1.3, and the pellet conductivity of particles doped with hydrochloric acid was 48 S/cm.

### Example 1

Polyaniline synthesized in Preparation Example 1 was dissolved in N-methylpyrrolidone (NMP) solvent to be 2 wt % solution, and 10 wt % of each of chlorinated polypropylene, triphenylsulfonium triflate, and polyacrylic acid with respect to polyaniline was added. Subsequently, the mixed solution was coated on a glass substrate having electrodes by doctor blading. The thickness measured using an Alpha step after being dried at room temperature for 24 hours was 3.9 microns.

### Example 2

Dodecylbenzenesulfonic acid (1 M) was dissolved in the polypyrrole synthesis reactor of Preparation Example 2, and a glass substrate coated with octadecylsiloxane was put therein to perform a polymerization reaction. Like this, the glass substrate was coated with polypyrrole, washed with methanol, and measured with electrodes. The film became brittle and cracks were observed after drying.

### Example 3

This example was performed in the same manner as Example 2, except that phosphomolybdic acid was added instead of dodecylbenzenesulfonic acid (1 M). 10% of polyethylene glycol and 2 wt % of trimethylbenzhydrylammonium iodide as a photobase generator were added thereto, mixed under ultrasonic agitation for 10 minutes, and filtered through a 2.7 micron syringe filter. A film was formed with a filtrate and its properties were measured. As a result, the film was not brittle but ductile, and sensitive to ultraviolet rays (UV lamp 4 W) and had an optical density of 0.08 at soft X-rays.

### Example 4

2 wt % of surface-treated carbon nanotubes with respect to aniline was placed in a reactor to be polymerized in the same manner as the polyaniline synthesis of Preparation Example 1. Subsequently, 1.5 w % of the thus synthesized polyaniline was dissolved in dimethylformamide (DMF) solvent and then EuCl₃ in a molar ratio of 1:1 with respect to polyaniline was dissolved therein. 10 wt % of poly(2-hydroxyethyl methacrylate)-co-(allyl methacrylate) as a binder resin was added thereto and subjected to ultrasonic agitation for 10 minutes, and then filtered through a 2.7 micron syringe filter. A film was formed with a filtrate and subjected to an X-ray examination. As a result, it was very sensitive to soft X-rays (1 to 20 kW), an intermediate power level.

### Example 5

In the same manner as Preparation Example 1, 0.2 mol % of 2-chloroaniline with respect to aniline was added, and polymerized to synthesize chlorine-substituted polyaniline copolymer. As a result of elemental analysis, the chlorine substitution was 9.8% and the thus synthesized polyaniline copolymer was well dissolved in N-methylpyrrolidone (NMP) solvent. A film was formed in the same manner as Example 1, and the properties were measured after being soaked in a 1 N hydrochloric acid solution for 6 hours.

### Example 6

2 g of polyaniline powder having a substituent of Example 5 was dissolved in a flask containing 50 mL ethanol/THF and then 2 g of iodine was dissolved therein. The mixture was stirred at room temperature for 50 hours, filtered, and washed with an excessive amount of water. The powder dried in an oven at 70° C. for a day was dissolved in dimethylsulfoxide, and 15 w % of an alkyl derivative of 4-sulfo-1,2-benzenedicarboxylic acid as a plasticizer and 5 wt % of diphenyliodonium hexafluorophosphate as a photoacid generator were dissolved therein to form a film.

### Example 7

Polyaniline synthesized in Preparation Example 1 was dissolved in metacresol and doped with camphorsulfonic acid. Subsequently, 5% of Irgacure 184 (1-hydroxycyclohexylphenylketone) as a photocuring agent and SAL 605 were added thereto, and then subjected to ultrasonic agitation for 2 hours. Subsequently, a film having a thickness of 0.5 microns was formed on a glass substrate with a filtrate filtered through a 1.2 micron syringe filter by spin coating.

### Example 8

Polyaniline synthesized in Preparation Example 1 was dissolved in N-methylpyrrolidone (NMP), and 20 wt % of each of orthochloroaniline and polyvinylphenol as a binder resin was added thereto. Then, 2% of LiBF₄ as a pseudodopant was added thereto and the mixture was then subjected to ultrasonic agitation for 2 hours. Subsequently, a film having a thickness of 0.5 microns was formed on a glass substrate with a filtrate filtered through a 1.2 micron syringe filter by spin coating.

### Example 9

Polyaniline synthesized in Preparation Example 1 was dissolved in a mixed solvent of ethanol and N-methylpyrrolidone (NMP) in a volume ratio of 1:1, and 10 wt % of each of iodine and gadolinium chloride was added thereto. Then, 10% of polyvinyl chloride was mixed with the solution, and stirred at 50° C. for 48 hours. Subsequently, a film having a thickness of 3.3 microns was formed with a filtrate filtered through a 2.7 micron syringe filter by doctor blading.

### Example 10

Polyaniline powder synthesized in Preparation Example 1 was dispersed in water, bromine was added thereto in a molar ratio of 1:2 at room temperature, and the mixture was subjected to the reaction for 48 hours. The density of the brominated polyaniline was increased to 2.37 g/mL compared with that of polyaniline of 1.24 g/mL. The brominated polyaniline was dissolved in N-methylpyrrolidone (NMP) solvent, and 10% of N-methylnifedipine as a photobase generator was added thereto. Subsequently, 10% of polyethyleneimine as a binder resin and 3% of PbI₂ as a converter material were dispersed therein.

### Example 11

This example was performed in the same manner as Example 10, except that the binder resin and the converter material were formed into a separate layer to be a multilayer.

### Example 12

An amine group of 2-hydroxyaniline was protected with a di-tert-butyl-dicarbonate protective group in a mixed solvent of tetrahydrofuran and water under sodium bicarbonate, and diethylene oxide was introduced into a hydroxy group using NaH and chloro-p-toluenesulfonate. After a deprotection reaction, the resulting solution was purified and subjected to copolymerization within about 5 mol % with respect to aniline in the same manner as Preparation Example 1. The resulting polymer was dissolved in a mixed solvent of ethylacetate and ethanol, and 0.02 M of silver nitrate and NdCl₃ were dissolved therein. Subsequently, a composition was prepared with 10% of polyacrylic acid as a binder resin to form a film.

### Example 13

Polyaniline nanoparticles synthesized in Preparation Example 1 were dispersed in formic acid/acetonitrile, and tin foil was put therein, and then maintained while stirring for 24 hours. The molten tin was bonded with polymer to filter a kind of metal-polyaniline composite and then dispersed again in tetrahydrofuran. Subsequently, 10 wt % of each of triphenylsulfonium hexafluoroantimonate as a photoacid generator and hydroxyethylcellulose as a binder resin was added thereto.

### Example 14

A di-tert-butyl-dicarbonate protective group vulnerable to acid or heat was introduced into the polyaniline synthesized in Preparation Example 1, thus preparing polyaniline. The preferable preparation method is disclosed in Korean Patent No. 10-458498, and a composition was prepared using the thus synthesized polyaniline in the same manner as Example 13.

### Example 15

15 wt % of a self-orienting metal compound (refer to Korean Patent No. 10-426344) with respect to the polyaniline synthesized in Preparation Example 1 was dissolved in metacresol to form a composition in the same manner as Example 12.

### Example 16

Polyaniline synthesized in Preparation Example 1 was dissolved in dimethylacetamide, and 15 wt % of terephthalic acid having two diacetylene derivatives [—O—(CH₂)₄—C≡C—C≡C—(CH)₉—CH₃] substituted on an aromatic ring, synthesized by the method disclosed in a literature (Angewandte Chemie International Edition, 43, 4197, 2004), was added thereto. Subsequently, 10% of ethylvinylacetate copolymer as a binder resin and CaWO₃ as a converter material were added thereto to form a composition.

[Test of Film Properties]

Conductivity, contrast, and wetness with respect to the films formed of compositions prepared in Examples 1 to 16 were measured by the following methods, and the results are shown in Table 1.

1. Measurement of Resistance and Conductivity

The electrical resistances of the coated films were measured with a commonly used four line probe method at room temperature and at a relative humidity of about 50%. Carbon paste was used for preventing corrosion when contacting gold wire electrodes. The resistances and conductivities of film samples with a thickness of about 0.1 to 100 μm (thickness t, width w) with respect to currents (i), voltages (V), and distances (l) between two external electrodes and two internal electrodes were measured with a Keithley instrument.

The conductivity was calculated using the following formula and the unit of the conductivity was Siemen/cm or S/cm.

Conductivity=(l×i)/(w×t×v)

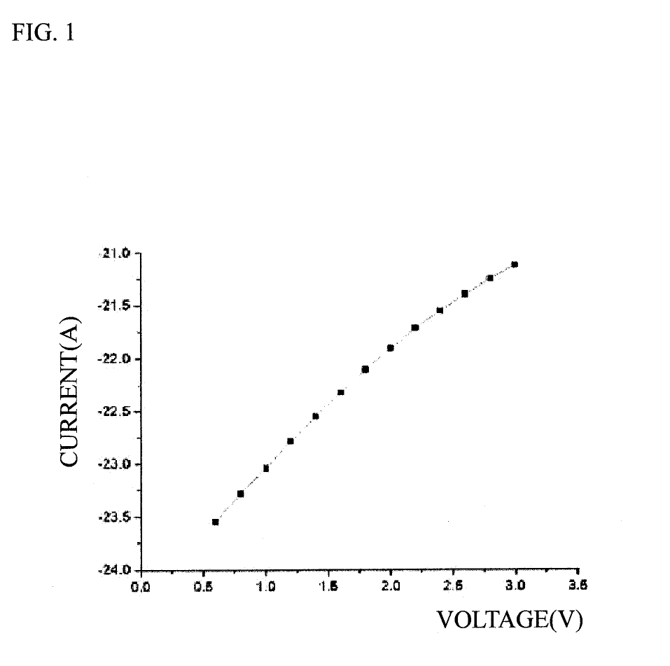

The current-voltage curve in FIG. 1 shows experimental results for the composition prepared in accordance with Example 5 of the present invention, and it has been found that ohmic contact was obtained in the measurement range. The conductivity was calculated from the slope of the curve, and the results are shown in Table 1.

2. Measurement of Resistance Variation in Compositions According to X-Ray Irradiation

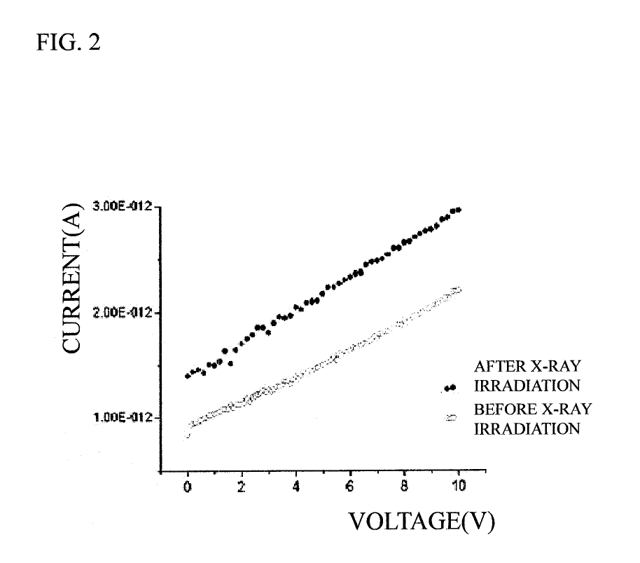

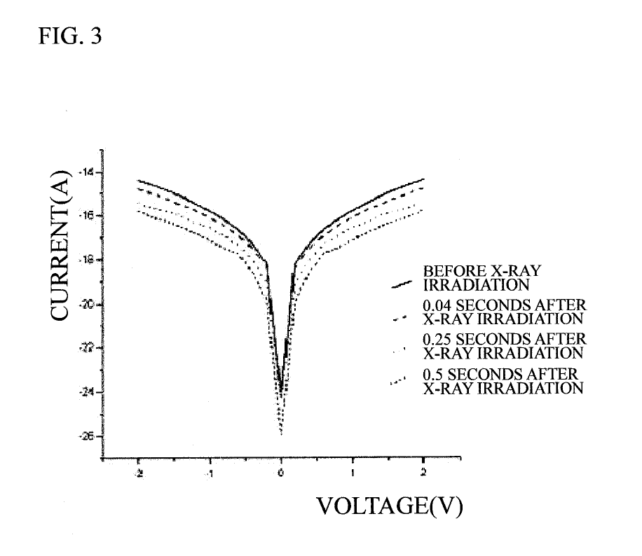

Electrodes were disposed on a glass substrate and the compositions in accordance with Examples 14 and 7 were coated into films having a thickness of 10 microns. The current-voltage curves obtained before and after X-ray irradiation are shown in FIGS. 2 and 3. Carbon paste was used for sample-electrode contact. X-rays were used at 70 kVp 10 mA of a tungsten anode X-ray tube for 1 second.

3. Measurement of Resistance Variation and Contrast of Films According to Radiation Doses of Compositions

X-ray energy generated by a molybdenum cathode was 20 keV and 40 keV at 5 mA. The resistance variation was measured under conditions where the distance between the sample and the X-ray tube was 50 cm and the exposure time was varied from 0.1 seconds to 2 minutes.

The radiation sensitivity represents the resistance variation caused by the reaction according to the change in the exposure time. The radiation sensitivities of the compositions of Examples 1 to 16 were represented as subject contrasts defined as follows by measuring the resistance variations of the films placed on the glass substrate. At this time, the measurement results of the radiation doses were obtained by relatively comparing the values without compensation for the X-ray tube. However, the measurement of the X-ray irradiation to the compositions may be obtained using the optical conductivity measured from the optical reflectivity or the microwave conductivity as well as the DC conductivity, and it is possible to obtain an image using the same. Since the resistance measured by forming the compositions into films having a known thickness depends on the degree of radiation exposure, and the contrast and response speed are related to a difference obtained by relatively comparing the resistance values between different regions, the contrast was defined as the following formula within a given effective resistance value range:

Contrast=(R1−R2)/R0

wherein R0 represents a resistance value before transmission, and R1 and R2 represent resistance values at different doses, R1 and R2 being measured by varying the exposure time as 0.05 seconds and 0.15 seconds. The contrasts of the compositions of Examples 1 to 16 are denoted as VG (very good) if the contrast is more than 10%, G (good) if it is in the range of 5 to 7%, and F (fair) if it is in the range of 1 to 3% in the following Table 1.

4. Wetness

The compositions in accordance with Examples 1 to 16 were dropped on polyester films having a thickness of 25 microns at room temperature, and then static contact angles were measured by a sessile drop method to analyze quality factors according to the sizes of the angles (based on 100 degrees), and the results are shown in Table 1.

TABLE 1

| | Conductivity | | |
|---|---|---|---|
| | (S/cm) × 10⁹ | Contrast | Wetness |
| Example 1 | 3.0 | G | ◯ |
| Example 2 | 26 | F | X |
| Example 3 | 0.8 | G | ◯ |
| Example 4 | 2.3 | VG | ◯ |
| Example 5 | 120 | G | ◯ |
| Example 6 | 0.07 | VG | Δ |
| Example 7 | 970 | G | ◯ |
| Example 8 | 66 | G | ◯ |
| Example 9 | 0.5 | VG | Δ |
| Example 10 | 1.9 | G | ◯ |
| Example 11 | 3.4 | VG | ◯ |
| Example 12 | 8.1 | G | ◯ |
| Example 13 | 78 | G | ◯ |
| Example 14 | 0.07 | F | ◯ |
| Example 15 | 8.3 | G | ◯ |
| Example 16 | 0.4 | VG | Δ |

As shown in Table 1, most of the conductive polymer compositions for radiographic imaging showing the electrical resistance variation amplified by radiation in accordance with the present invention showed the resistance variations of more than 5% before and after irradiation. That is, it can be understood that the electrical resistance variation can be effectively amplified and thus the composition in accordance with the present invention may be effectively used as a material for the detection and recording of radiation. Especially, it can be understood that the composition containing a transition metal salt shows a resistance variation of more than 10% since the heavy metal salt is a pseudodopant and further causes an interaction, and thus it is possible to effectively detect and record radiation of low dose.

1. A conductive polymer composition for radiographic imaging prepared by mixing 0.1 to 2 equivalent of at least one photosensitive compound selected from the group consisting of a carbon nanotube, a photodegradable dopant, a photocuring agent, an organic electron acceptor including a halogen atom, a Lewis basic dopant, and a pseudodopant, with one equivalent of a conductive polymer, the conductive polymer composition for radiographic imaging showing an electrical resistance variation amplified by radiation.

2. The conductive polymer composition for radiographic imaging of claim 1, wherein the photodegradable dopant is at least one photoacid generator selected from the group consisting of 4,4′-isopropylidene-bis-(2,6-dibromophenol), triphenylsulfonium hexafluorophosphate, triphenylsulfonium hexafluoroantimonate, triphenylsulfonium hexafluoroarsenate, triphenylsulfonium triflate, diphenyl(4-methoxyphenyl)sulfonium triflate, diphenyliodonium hexafluorophosphate, diphenyliodonium hexafluoroantimonate, 4-methoxydiphenyliodonium triflate, (4-hydroxycyclohexyl)cyclohexyl-4-vinylbenzenesulfonate, (4-hydroxycyclohexyl)cyclohexyl-4-methylbenzenesulfonate, 4-hydroxycyclohexyl-4-vinylbenzenesulfonate, 4-hydroxycyclohexyl-4-methylbenzenesulfonate, and SAL 605.

3. The conductive polymer composition for radiographic imaging of claim 1, wherein the photodegradable dopant is at least one photobase generator selected from the group consisting of [(2,6-dinitrobenzyl)oxycarbonyl]diphenylamine, [(2,6-dinitrobenzyl)oxycarbonyl]cyclohexylamine), [(2,6-dinitrobenzyl)oxycarbonyl]hexane-1,6-diamine, N-methylnifedipine, quaternary ammonium dithiocarbamate, trimethylbenzhydrylammonium triflate, trimethylbenzhydrylammonium iodide, trimethylflorenylammonium iodide, o-nitrobenzyl carbamate, trimethylbenzhydrylammonium iodide), and O-acryloyl acetophenone oxime.

4. The conductive polymer composition for radiographic imaging of claim 1, wherein the photocuring agent is 1-hydroxycyclohexylphenylketone or diacetylene derivative.

5. The conductive polymer composition for radiographic imaging of claim 4, wherein the diacetylene derivative is aromatic 1,4-dicarboxylic acid having a carboxyl group attached to the para position, the aromatic dicarboxylic acid having at least one —O—(CH₂)ₚ—C≡C—C≡C—(CH₂)_{q}—CH₃, or —O—(CH₂)ₚ—C≡C—C≡C—(CH₂)_{q}—CH₃ and —O—(CH₂)ᵣ—CH₃ wherein p, q and r are independently integers from 1 to 12, attached to an aromatic ring.

6. The conductive polymer composition for radiographic imaging of claim 1, wherein the organic electron acceptor including a halogen atom is at least one selected from the group consisting of I₂, Br₂, tetracyanoethylene (TCNE), 2,3-dichloro-5,6-dicyano-p-benzoquinone, o-chloranil, and o-bromanil.

7. The conductive polymer composition for radiographic imaging of claim 1, wherein the Lewis basic dopant is a chloride, a nitrogen oxide or a phosphorus oxide of Gd³⁺, Eu³⁺, La³⁺, Y³⁺, Lu³⁺, Ce³⁺, Nd³⁺, Tb³⁺, Zn²⁺, Mn²⁺, Ni²⁺, Cu²⁺, Pb²⁺, Pd²⁺, Ca²⁺, Fe³⁺, Au³⁺, Ti⁴⁺, Sn⁴⁺, Zr⁴⁺, Mo⁵⁺, Ag¹⁺, or W⁶⁺.

8. The conductive polymer composition for radiographic imaging of claim 1, wherein the pseudodopant is at least one selected from the group consisting of LiPF₆, LiAsF₆, LiClO₄, LiBF₄, and NaBF₄.

9. The conductive polymer composition for radiographic imaging of claim 1, wherein the conductive polymer is selected from the group consisting of polyaniline having or not having a substituent on an aromatic ring, polypyrrole having or not having a substituent on an aromatic ring, polythiophene having or not having a substituent on an aromatic ring, and polyacetylene having or not having an alkyl or alkoxy substituent, in which the substituent on the aromatic ring is I, Cl, Br, or (—OCH₂CH₂)ₙ—OCH₂CH₃ wherein n is an integer from 1 to 12.

10. The conductive polymer composition for radiographic imaging of claim 9, wherein the conductive polymer is selected from the group consisting of polyaniline having or not having a substituent on an aromatic ring, polypyrrole having or not having a substituent on an aromatic ring, and polythiophene having or not having a substituent on an aromatic ring, in which a hetero atom of the conductive polymer is substituted with di-tert-butyl-dicarbonate, or 3,4-dihydro-2H-pyran-tert-butyl-dicarbonate.

11. The conductive polymer composition for radiographic imaging of claim 9, wherein the conductive polymer is a conductive polymer salt doped with an organic acid or inorganic acid having a pKa of less than 5.

12. The conductive polymer composition for radiographic imaging of claim 11, wherein the organic acid or inorganic acid having a pKa of less than 5 is at least one selected from the group consisting of hydrochloric acid, bromic acid, sulfuric acid, pyruvic acid, phosphoric acid, dichloroacetic acid, acrylic acid, citric acid, formic acid, methanesulfonic acid, benzenesulfonic acid, p-toluenesulfonic acid, camphorsulfonic acid, dodecylbenzenesulfonic acid, dinonylnaphthalenesulfonic acid, poly(styrenesulfonic acid), polyacrylic acid, heteropolyanion, C₁-C₂₄ alkyl, oxidized C₁-C₂₄ alkyl, 4-sulfophthalic acid diester, 4-sulfo-1,2-benzenecarboxylic acid, C₁-C₂₄ alkyl ester, bis(2-ethylhexyl)hydrogen phosphate, and 2-acrylamido-2-methyl-1-propanesulfonic acid.

13. The conductive polymer composition for radiographic imaging of claim 1, further comprising at least one binder resin selected from the group consisting of polyvinyl acetate, polyacrylic acid, polyol, acrylate-styrene copolymer, polyethylene glycol, polyvinyl alcohol, polyvinylpyrrolidone, polyvinyl chloride (PVC), polyacrylate, nitrocellulose, poly[(2-hydroxyethyl methacrylate)-co-(allyl methacrylate)], poly(butene-1-sulfone), poly(2,3-dichloro-1-propylacrylate), poly(2-fluoroethyl methacrylate), ethylvinylacetate copolymer, cellulose triacetate, hydroxyethylcellulose, poly(hexafluorobutyl methacrylate), polymethacrylonitrile, gelatin, polyisobutyl methacrylate, poly(vinyl-2-furylacrylate), poly(vinylcinnamilidene acetate), chlorinated polypropylene, polyvinylphenol, halogen-substituted polyvinylphenol, polyethyleneimine, nitrocellulose, celluloseacetatebutylate, and cellulose propionate.

14. The conductive polymer composition for radiographic imaging of claim 1, further comprising at least one plasticizer selected from the group consisting of propionic acid, heptanoic acid, boric acid, 4-sulfophthalic acid diester, and 4-sulfo-1,2-benzenedicarboxylic acid.

15. The conductive polymer composition for radiographic imaging of claim 1, further comprising a dopant-plasticizer.

16. The conductive polymer composition for radiographic imaging of claim 15, wherein the dopant-plasticizer is selected from the group consisting of di-2-ethylhexylsulfosuccinic acid, 1,2-benzenedicarboxylic acid, 4-sulfo-1,2-di(2-alkyl)ester, 1,2-benzenedicarboxylic acid, 4-sulfo-1,2-di(2-alkoxy)ester, diisooctyl phosphate, di(m-tolyl)phosphate, and diphenyl phosphate.

17. The conductive polymer composition for radiographic imaging of claim 1, further comprising at least one converter material selected from the group consisting of barium titanate, MgO, barium silicate, BaI₂, BaSO₄, BaBr₂, SnIₐ, H₂WO₄, ZnO, CsBr, CsI, ZnS, Gd₂O₂S, Y₂O₂S, CaWO₃, H₃BO₃, ZnSiO₄, ZnBr₂, ZnSO₄, PbI₂, and Na⁺-montmorillonite, or a separate converter layer thereof.

18. The conductive polymer composition for radiographic imaging of claim 1, wherein the photosensitive compound is at least one selected from the group consisting of fullerene, fullerene having a sulfonyl group, triphenylsulfonium triflate, trimethylbenzhydrylammonium iodide, carbon nanotube, EuCl₃, diphenyliodonium hexafluorophosphate, 1-hydroxycyclohexylphenylketone, SAL 605, o-chloranil, LiBF₄, gadolinium chloride (GdCl₃), N-methylnifedipine, AgNO₃, NdCl₃, triphenylsulfonium hexafluoroantimonate, and terephthalic acid having two diacetylene derivatives [—O—(CH₂)₄—C≡C—C≡C—(CH)₉—CH₃] substituted on an aromatic ring.

19. The conductive polymer composition for radiographic imaging of claim 18, further comprising: at least one binder resin selected from the group consisting of chlorinated polypropylene, polyethylene glycol, poly[(2-hydroxyethyl methacrylate)-co-(allyl methacrylate)], polyvinylphenol, polyvinyl chloride, polyethyleneimine, polyacrylic acid, hydroxyethylcellulose, and ethylvinylacetate copolymer; a plasticizer such as 4-sulfo-1,2-benzenedicarboxylic acid; or a converter material such as PbI₂ or CaWO₃.
